(19) United States
(12) Patent Application Publication
(10) Pub. No.: US 2015/0146888 A1
(43) Pub. Date: May 28, 2015

(54) MEMS MICROPHONE PACKAGE AND METHOD OF MANUFACTURING THE SAME

(71) Applicant: SAMSUNG ELECTRO-MECHANICS CO., LTD., Suwon (KR)

(72) Inventor: Sun Ho KIM, Suwon (KR)

(73) Assignee: SAMSUNG ELECTRO-MECHANICS CO., LTD., Suwon (KR)

(21) Appl. No.: 14/171,354

(22) Filed: Feb. 3, 2014

(30) Foreign Application Priority Data
Nov. 26, 2013 (KR) 10-2013-0144917

(51) Int. Cl. H04R 17/02

(52) U.S. Cl. CPC H04R 17/02
USPC 381/114

(57) ABSTRACT

There is provided a micro electro mechanical system (MEMS) microphone package including: an MEMS microphone chip having an internal space formed therein; a substrate having the MEMS microphone chip mounted thereon; an ASIC chip disposed in the internal space formed within the MEMS microphone chip; and a case bonded to the substrate and having an internal space formed therein in order to accommodate the MEMS microphone chip.

### CROSS-REFERENCE TO RELATED APPLICATION

This application claims the benefit of Korean Patent Application No. 10-2013-0144917 filed on Nov. 26, 2013, with the Korean Intellectual Property Office, the disclosure of which is incorporated herein by reference.

### BACKGROUND

The present disclosure relates to a micro electro mechanical system (MEMS) microphone package and a method of manufacturing the same.

A microphone is required in a mobile communications terminal. A traditional condenser microphone includes a paired diaphragm and back plate forming a capacitor (C), changed depending on sound pressure and a junction field effect transistor (JFET) buffering an output signal.

Recently, semiconductor machining technology using micromachining, improved as compared with that used in manufacturing traditional condenser microphones, a technology used for integrating a microdevice in the microphone, has been used.

In this technology known as a micro electro mechanical system (MEMS), a micro sensor, actuator, and electronic-mechanical structure on μm unit scale may be manufactured using micromachining technology utilizing a semiconductor process, particularly, integrated circuit technology.

The MEMS microphone manufactured using the micromachining technology, manufactured by miniaturizing and integrating traditional microphone components such as a diaphragm according to the related art, a spacer ring, an insulating ring, a back plate, a conduction ring, and the like, through ultra-precision micromachining to improve the performance thereof while allowing for the implementation of multifunctionalization, may have improved stability and reliability.

Meanwhile, the MEMS microphone manufacturing using the micromachining technology includes an MEMS chip and an application specific integrated circuit (ASIC) chip, which are generally disposed in parallel with each other on a substrate.

However, the disposition of the chips in this form has a limitation in allowing for the miniaturization the MEMS microphone.

For reference, Patent Document 1 discloses an MEMS microphone according to the related art.

### RELATED ART DOCUMENT

(Patent Document 1) Korean Patent No. 10-1039256

### SUMMARY

An aspect of the present disclosure may provide a micro electromechanical system (MEMS) microphone package capable of having a reduced overall size and being manufactured using a simplified process by disposing an application specific integrated circuit (ASIC) chip in an internal space formed within an MEMS microphone chip and electrically connecting the ASIC chip to a substrate by a solder ball, and a method of manufacturing the same.

According to an aspect of the present disclosure, an MEMS microphone package may include: an MEMS microphone chip having an internal space formed therein; a substrate having the MEMS microphone chip mounted thereon; an ASIC chip disposed in the internal space formed within the MEMS microphone chip; and a case bonded to the substrate and having an internal space formed therein in order to accommodate the MEMS microphone chip.

The ASIC chip and the MEMS microphone chip may be electrically connected to the substrate by solder balls.

The ASIC chip and the MEMS microphone chip may be electrically connected to each other by conductive patterns formed on the substrate.

At least one of the case and the substrate may have a sound hole formed therein.

In the case in which the sound hole is formed in the substrate, it may be covered by the MEMS microphone chip.

The ASIC chip may be electrically connected to the substrate by solder balls, and the MEMS microphone chip may be electrically connected to the substrate and the ASIC chip by a bonding wire.

The substrate may be any one of a printed circuit board (PCB), a metal plate, a ceramic plate, a plastic-based plate, and a resin plate.

The case may be formed of metal.

According to another aspect of the present disclosure, an MEMS microphone package may include: a substrate having a sound hole formed therein; a case having an internal space provided in a manner in which one side thereof is opened and having the substrate coupled to one side thereof that is opened; an ASIC chip electrically connected to the substrate by solder balls attached to a lower portion thereof; and an MEMS microphone chip having an internal space formed therein so as to enclose the ASIC chip and the sound hole and electrically connected to the substrate by solder balls attached to a lower portion thereof, wherein the ASIC chip and the MEMS microphone chip are electrically connected to each other by conductive patterns formed on the substrate.

According to another aspect of the present disclosure, a method of manufacturing an MEMS microphone package may include: providing a substrate having a sound hole formed therein; connecting an ASIC chip to the substrate, the ASIC chip having solder balls attached thereto; connecting an MEMS microphone chip to the substrate so that the MEMS microphone chip encloses the sound hole and the ASIC chip; and coupling a case to the substrate so that the MEMS microphone chip and the ASIC chip are accommodated in an internal space of the case.

The providing of the substrate may include forming conductive patterns on the substrate.

In the connecting of the MEMS microphone chip to the substrate, the ASIC chip and the sound hole may be disposed in an internal space formed within the MEMS microphone chip.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is an exploded perspective view of a micro electro mechanical system (MEMS) microphone package according to an exemplary embodiment of the present disclosure;

FIG. 2 is a schematic cross-sectional view of the MEMS microphone package according to an exemplary embodiment of the present disclosure;

FIG. 3 is a flow chart showing a process of manufacturing an MEMS microphone package according to an exemplary embodiment of the present disclosure; and

FIG. 4 is a schematic cross-sectional view of an MEMS microphone package according to another exemplary embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

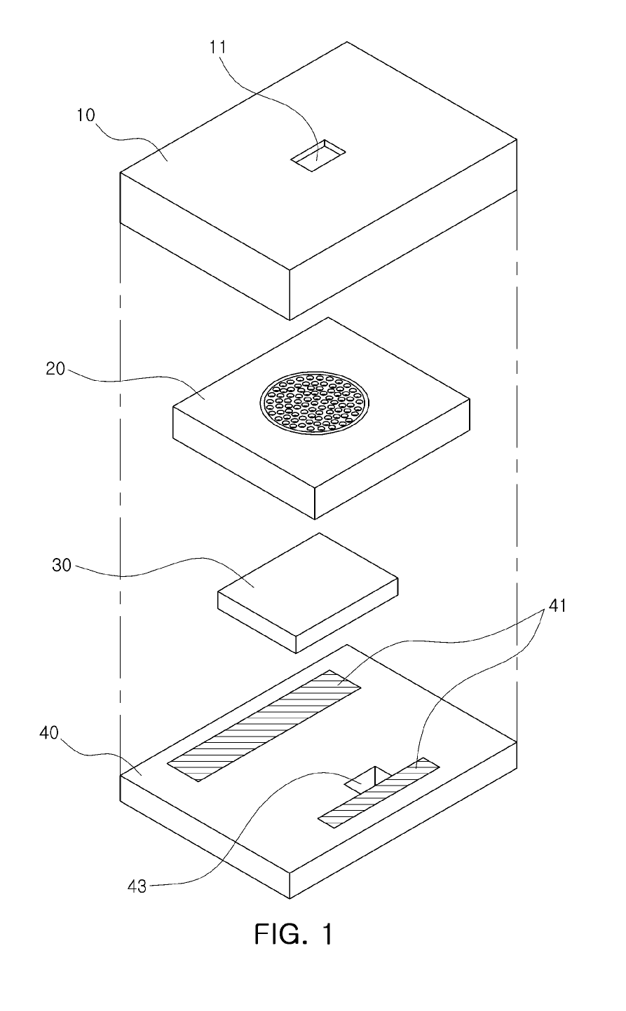

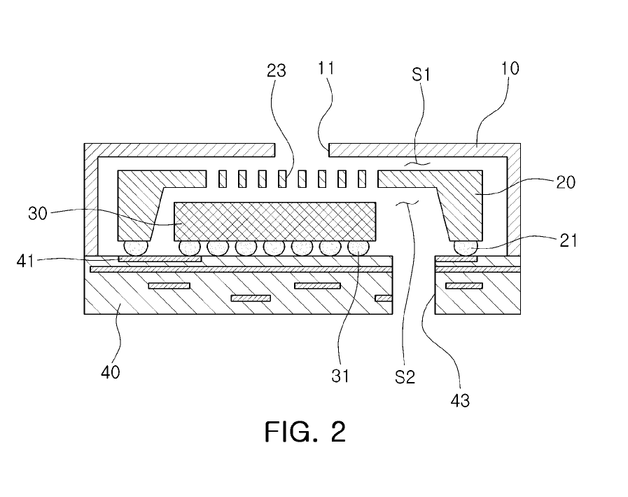

FIG. 1 is an exploded perspective view of a micro electro mechanical system (MEMS) microphone package according to an exemplary embodiment of the present disclosure; and FIG. 2 is a schematic cross-sectional view of the MEMS microphone package according to an exemplary embodiment of the present disclosure.

Referring to FIGS. 1 and 2, an MEMS microphone package according to an exemplary embodiment of the present disclosure, which is a device converting an acoustic wave signal such as voice, sound, audio, or the like, into an electrical signal, may include a substrate 40, an application specific integrated circuit (ASIC) chip 30, an MEMS microphone chip 20, and a case 10.

The substrate 40 may be any one of a printed circuit board (PCB), a metal plate, a ceramic plate, a plastic-based plate, and a resin plate, and may have conductive patterns 41 formed thereon.

The MEMS microphone chip 20 and the ASIC chip 30 may be mounted on the substrate 40 to thereby be electrically connected to the substrate 40 and may be electrically connected to each other.

The case 10 may provide an internal space S1 in a form in which one side thereof is opened and may have the substrate 40 coupled to one side thereof that is opened.

For example, the case 10 may have a rectangular parallelepiped or cubic shape of which a lower surface is opened, but is not limited thereto. That is, the case 10 may have various shapes such as a cylindrical shape, an oval shape, or the like.

The case 10 may be formed of metal. The case 10 formed of metal may be coupled to the substrate 40 to be grounded, thereby shielding electromagnetic waves such as electromagnetic interference (EMI) generated from the outside.

The MEMS microphone chip 20 and the ASIC chip 30 mounted on the substrate 40 may be disposed in the internal space S1 of the case 10.

Here, at least one of the case 10 and the substrate 40 may have a sound hole 11 or 43 formed therein, and the internal space S1 of the case 10 except for the sound hole 11 or 43 may be sealed by coupling of the case 10 and the substrate 40.

The sound hole 11 or 43 may penetrate through at least one of the case 10 and the substrate 40 and external sounds may be introduced through the sound hole 11 or 43.

The MEMS microphone chip 20 may also have an internal space S2 formed therein, and the internal space S2 of the MEMS microphone chip 20 and the internal space S1 of the case 10 may serve as a back chamber.

A structure of the MEMS microphone chip 20 will be schematically described. The MEMS microphone chip 20 may include an insulating layer formed on an upper portion of a single crystal silicon body and the internal space S2 and a diaphragm formed by an etching process, wherein the internal space S2 serves as the back chamber. In addition, a back plate may be deposited on the diaphragm.

The diaphragm and the back plate may have a plurality of holes 23 formed therein, such that air pressure of the internal space S2 formed in the MEMS microphone chip 20 and external air pressure of the MEMS microphone chip 20 may be balanced.

The MEMS microphone chip 20 may be mounted on the substrate 40.

The MEMS microphone chip 20 may have solder balls 21 attached to a lower portion thereof, wherein the solder balls 21 may be connected to the conductive patterns 41, such that the MEMS microphone chip 20 may be electrically connected to the substrate 40.

The ASIC chip 30 may be an application specific integrated circuit chip and may be a chip in which a circuit converting a sound signal into an electrical signal depending on a change in a capacitance detected by the MEMS microphone chip 20 is integrated.

The ASIC chip 30 may serve to receive and amplify an electrical signal generated by the MEMS microphone chip 20.

The ASIC chip 30 may be mounted on the substrate 40 and may have solder balls 31 attached to a lower portion thereof, wherein the solder balls 31 may be connected to the conductive patterns 41, such that the ASIC chip 30 may be electrically connected to the substrate 40.

In addition, since the ASIC chip 30 and the MEMS microphone chip 20 are connected to the conductive patterns 41 formed on the substrate 40 by the solder balls 31 and 21, respectively, they may be electrically connected to each other by the conductive patterns 41 formed on the substrate 40.

Here, the ASIC chip 30 may be disposed in the internal space S2 formed in the MEMS microphone chip 20.

The MEMS microphone chip 20 may be disposed so as to enclose the ASIC chip 30, such that the ASIC chip 30 may be positioned in the internal space S2 of the MEMS microphone chip 20.

Here, in the case in which the sound hole 43 is formed in the substrate 40, it may be covered by the MEMS microphone chip 20.

That is, the MEMS microphone chip 20 having the internal space S2 formed therein may be disposed so as to enclose the ASIC chip 30 and the sound hole 43 formed in the substrate 40.

Since the ASIC chip 30 is disposed in the internal space S2 formed in the MEMS microphone chip 20, an overall size of the MEMS microphone package according to an exemplary embodiment of the present disclosure may be determined by a size of the MEMS microphone chip 20.

Therefore, the MEMS microphone package may be miniaturized by controlling the size of the MEMS microphone chip 20.

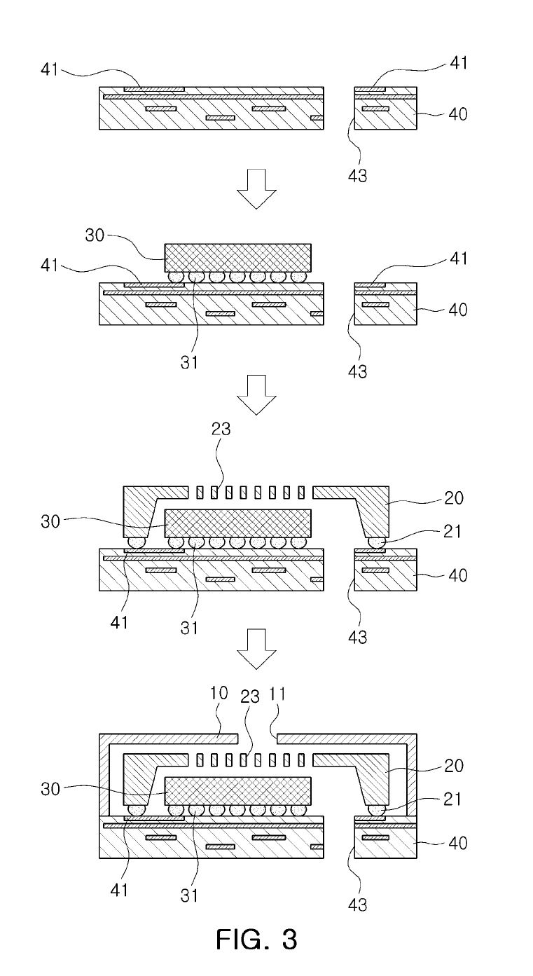

FIG. 3 is a flow chart showing a process of manufacturing an MEMS microphone package according to an exemplary embodiment of the present disclosure.

A method of manufacturing an MEMS microphone package according to an exemplary embodiment of the present disclosure will be described with reference to FIG. 3.

First, the conductive patterns 41 may be formed on the substrate 40, which is any one of a printed circuit board (PCB), a metal plate, a ceramic plate, a plastic-based plate, and a resin plate, and the sound hole 43 may be formed in the substrate 40.

Next, the ASIC chip 30 may be electrically connected to the substrate 40.

Here, the ASIC chip 30 may have the solder balls 31 attached thereto, wherein the solder balls 31 may be connected to the conductive patterns 41 formed on the substrate 40, such that the ASIC chip 30 and the substrate 40 may be electrically connected to each other.

Next, the MEMS microphone chip 20 may be connected to the substrate 40 so as to enclose the sound hole 43 and the ASIC chip 30.

The MEMS microphone chip 20 may have the solder balls 21 attached thereto, wherein the solder balls 21 may be connected to the conductive patterns 41 formed on the substrate 40, such that the MEMS microphone chip 20 and the substrate 40 may be electrically connected to each other.

Here, the sound hole 43 and the ASIC chip 30 may be positioned in the internal space S2 formed in the MEMS microphone chip 20.

The MEMS microphone chip 20 and the ASIC chip 30 may be electrically connected to each other by the conductive patterns 41 formed on the substrate 40.

Next, the case 10 having opened one side and providing the internal space S1 may be coupled to the substrate 40.

The internal space S1 formed in the case 10 may have the MEMS microphone chip 20 and the ASIC chip 30 accommodated therein.

As described above, the MEMS microphone chip 20 and the ASIC chip 30 may be electrically connected to the substrate 40 by performing a die attaching process only twice. Since the MEMS microphone chip 20 and the ASIC chip 30 may be electrically connected to the substrate 40, a manufacturing process may be simplified.

In addition, since the ASIC chip 30 is disposed in the internal space S2 formed in the MEMS microphone chip 20, an overall size of the MEMS microphone package according to an exemplary embodiment of the present disclosure may be determined by a size of the MEMS microphone chip 20.

Therefore, the MEMS microphone package may be miniaturized by controlling the size of the MEMS microphone chip 20.

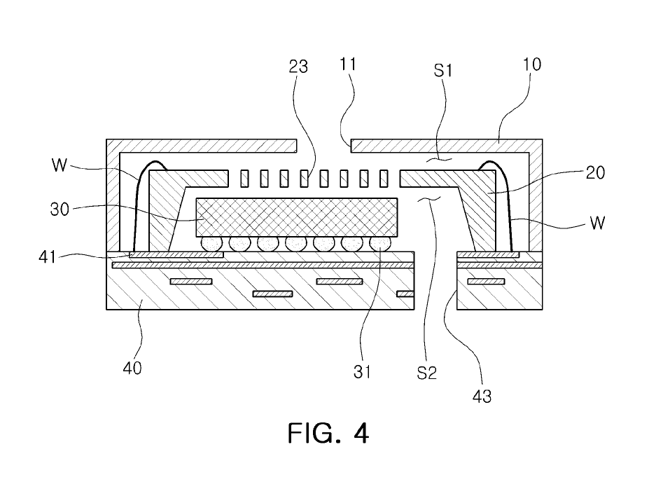

FIG. 4 is a schematic cross-sectional view of an MEMS microphone package according to another exemplary embodiment of the present disclosure.

Referring to FIG. 4, in an MEMS microphone package according to another exemplary embodiment of the present disclosure, an MEMS microphone chip 20 may be connected to a substrate 40 and an ASIC chip 30 by a bonding wire W.

The substrate 40 may be any one of a printed circuit board (PCB), a metal plate, a ceramic plate, a plastic-based plate, and a resin plate, and may have conductive patterns 41 formed thereon.

The MEMS microphone chip 20 and the ASIC chip 30 may be mounted on the substrate 40 to thereby be electrically connected to the substrate 40 and may be electrically connected to each other.

The case 10 may provide an internal space S1 in a form in which one side thereof is opened and may have the substrate 40 coupled to one side thereof that is opened.

The MEMS microphone chip 20 and the ASIC chip 30 mounted on the substrate 40 may be disposed in the internal space S1 of the case 10.

Here, at least one of the case 10 and the substrate 40 may have a sound hole 11 or 43 formed therein, and the internal space S1 of the case 10 except for the sound hole 11 or 43 may be sealed by coupling between the case 10 and the substrate 40.

The sound hole 11 or 43 may penetrate through at least one of the case 10 and the substrate 40 and external sound may be introduced through the sound hole 11 or 43.

The MEMS microphone chip 20 may also have an internal space S2 formed therein, and the internal space S2 of the MEMS microphone chip 20 and the internal space S1 of the case 10 may serve as a back chamber.

A structure of the MEMS microphone chip 20 will be schematically described. The MEMS microphone chip 20 may include an insulating layer formed on an upper portion of a single crystal silicon body and the internal space S2 and a diaphragm formed by an etching process, wherein the internal space S2 serves as the back chamber. In addition, a back plate may be deposited on the diaphragm.

The diaphragm and the back plate may have a plurality of holes 23 formed therein, such that air pressure of the internal space S2 formed in the MEMS microphone chip 20 and external air pressure of the MEMS microphone chip 20 may be balanced.

The MEMS microphone chip 20 may be mounted on the substrate 40.

The MEMS microphone chip 20 may be electrically connected to the substrate 40 by the bonding wire W.

The ASIC chip 30 may be an application specific integrated circuit chip and may be a chip in which a circuit converting a sound signal into an electrical signal depending on a change in a capacitance detected by the MEMS microphone chip 20 is integrated.

The ASIC chip 30 may serve to receive and amplify an electrical signal generated by the MEMS microphone chip 20.

The ASIC chip 30 may be mounted on the substrate 40 and may have solder balls 31 attached to a lower portion thereof, wherein the solder balls 31 may be connected to the conductive patterns 41, such that the ASIC chip 30 may be electrically connected to the substrate 40.

In addition, since the MEMS microphone chip 20 is connected to the conductive pattern 41 formed on the substrate 40 by the bonding wire W, the ASIC chip 30 and the MEMS microphone chip 20 may be electrically connected to each other by the conductive patterns 41 formed on the substrate 40.

Here, the ASIC chip 30 may be disposed in the internal space S2 formed in the MEMS microphone chip 20.

The MEMS microphone chip 20 may be disposed so as to enclose the ASIC chip 30, such that the ASIC chip 30 may be positioned in the internal space S2 of the MEMS microphone chip 20.

Here, in the case in which the sound hole 43 is formed in the substrate 40, it may be covered by the MEMS microphone chip 20.

That is, the MEMS microphone chip 20 having the internal space S2 formed therein may be disposed so as to enclose the ASIC chip 30 and the sound hole 43 formed in the substrate 40.

As set forth above, with the MEMS microphone package and the method of manufacturing the same according to an exemplary embodiment of the present disclosure, the ASIC chip may be disposed in the internal space formed within the MEMS microphone chip and be electrically connected to the substrate by there solder ball, whereby an overall size of the MEMS microphone package may be decreased and a manufacturing process thereof may be simplified.

While exemplary embodiments have been shown and described above, it will be apparent to those skilled in the art that modifications and variations could be made without departing from the spirit and scope of the present disclosure as defined by the appended claims.

What is claimed is:

1. A micro electro mechanical system (MEMS) microphone package comprising:
an MEMS microphone chip having an internal space formed therein;
a substrate having the MEMS microphone chip mounted thereon;
an application specific integrated circuit (ASIC) chip disposed in the internal space formed within the MEMS microphone chip; and
a case bonded to the substrate and having an internal space formed therein in order to accommodate the MEMS microphone chip.

2. The MEMS microphone package of claim 1, wherein the ASIC chip and the MEMS microphone chip are electrically connected to the substrate by solder balls.

3. The MEMS microphone package of claim 2, wherein the ASIC chip and the MEMS microphone chip are electrically connected to each other by conductive patterns formed on the substrate.

4. The MEMS microphone package of claim 1, wherein at least one of the case and the substrate has a sound hole formed therein.

5. The MEMS microphone package of claim 4, wherein in the case in which the sound hole is formed in the substrate, it is covered by the MEMS microphone chip.

6. The MEMS microphone package of claim 1, wherein the ASIC chip is electrically connected to the substrate by solder balls, and the MEMS microphone chip is electrically connected to the substrate and the ASIC chip by a bonding wire.

7. The MEMS microphone package of claim 1, wherein the substrate is any one of a printed circuit board (PCB), a metal plate, a ceramic plate, a plastic-based plate, and a resin plate.

8. The MEMS microphone package of claim 1, wherein the case is formed of metal.

9. An MEMS microphone package comprising:
a substrate having a sound hole formed therein;
a case having an internal space provided in a manner in which one side thereof is opened and having the substrate coupled to one side thereof that is opened;
an ASIC chip electrically connected to the substrate by solder balls attached to a lower portion thereof; and
an MEMS microphone chip having an internal space formed therein so as to enclose the ASIC chip and the sound hole and electrically connected to the substrate by solder balls attached to a lower portion thereof,
wherein the ASIC chip and the MEMS microphone chip are electrically connected to each other by conductive patterns formed on the substrate.

10. A method of manufacturing an MEMS microphone package, comprising:
providing a substrate having a sound hole formed therein;
connecting an ASIC chip to the substrate, the ASIC chip having solder balls attached thereto;
connecting an MEMS microphone chip to the substrate so that the MEMS microphone chip encloses the sound hole and the ASIC chip; and
coupling a case to the substrate so that the MEMS microphone chip and the ASIC chip are accommodated in an internal space of the case.

11. The method of claim 10, wherein the providing of the substrate includes forming conductive patterns on the substrate.

12. The method of claim 10, wherein in the connecting of the MEMS microphone chip to the substrate, the ASIC chip and the sound hole are disposed in an internal space formed within the MEMS microphone chip.
